(19) United States
(12) Patent Application Publication
(10) Pub. No.: US 2006/0254280 A1
(43) Pub. Date: Nov. 16, 2006

(54) Combined cycle power plant using compressor air extraction

(75) Inventors: Michael Briesch, Orlando, FL (US); Andrew Schmedeman, Orlando, FL (US); Erich Schmid, Marloffstein (DE)

Correspondence Address: Siemens Corporation;Intellectual Property Department, 170 Wood Avenue South, Iselin, NJ, 08830, US

(73) Assignee: Siemens Westinghouse Power Corporation

(21) Appl. No.: 11/127,476

(22) Filed: May 12, 2005

(51) Int. Cl. F02C 6/18

(52) U.S. Cl. 60/772; 60/39.182

(57) ABSTRACT

A combined cycle power plant (100) utilizing a compressor air bleed (62) as a source of heat for generating steam in a steam generator (78) for supplying the gland seals of the steam turbine (3) and as a motive force for an air ejector (90) for evacuating the condenser (8) during plant start-up. The compressor air bleed avoids delay awaiting the availability of steam from the heat recovery steam generator (4) without the need for an auxiliary boiler.

### FIELD OF THE INVENTION

This invention relates generally to the field of combined cycle power plants.

### BACKGROUND OF THE INVENTION

Combined cycle power plants are known to include a gas portion and a steam portion. The gas portion includes a gas turbine engine powered by the combustion of a fuel such as natural gas or fuel oil. A steam turbine of the steam portion is powered by steam that is generated by the cooling of the gas turbine exhaust in a heat recovery steam generator (HRSG). The gas turbine and the steam turbine typically provide shaft power for one or more electrical generators.

The steam portion includes a condenser for converting expanded steam received from the outlet of the steam turbine into condensate for delivery to the heat recovery steam generator. A vacuum is maintained in the condenser during operation by the condensation of steam. During start-up of the plant, the condenser vacuum is established by operating a vacuum pump, such as a mechanical pump or a jet pump. U.S. Pat. No. 6,755,023, incorporated by reference herein, describes the use of a steam jet air evacuation pump for evacuating a power plant condenser. Steam is also needed for supply to the steam turbine shaft gland seals. U.S. Pat. No. 5,388,411, incorporated by reference herein, illustrates a power plant wherein gland seal steam is provided from the heat recovery steam generator.

Steam is available from the heat recovery steam generator of a combined cycle plant only after a considerable delay due to thermal lag and thermal stress limitations inherent in the system. In order to avoid delaying the start-up of the plant while awaiting steam delivery from the HRSG, an auxiliary boiler may be used to provide steam. Auxiliary boiler steam may be provided to power a steam jet pump for evacuation of the condenser, and it may be provided to the gland seals of the steam turbine. While the use of auxiliary boiler steam provides a benefit by reducing the start-up time for a combined cycle power plant, the use of an auxiliary boiler increases installation, operation and maintenance costs. Because an auxiliary boiler produces airborne emissions, there may also be licensing/permit implications resulting from the use of an auxiliary boiler steam source.

### BRIEF DESCRIPTION OF THE DRAWINGS

The invention is explained in following description in view of the drawings that show:

FIG. 1 is a schematic illustration of a combined cycle power plant utilizing compressed air bled from the gas turbine engine compressor to produce gland seal steam and to power a condenser evacuation jet pump.

FIG. 2 is a schematic illustration of a gland steam and condenser evacuation equipment skid utilized in the power plant of FIG. 1.

### DETAILED DESCRIPTION OF THE INVENTION

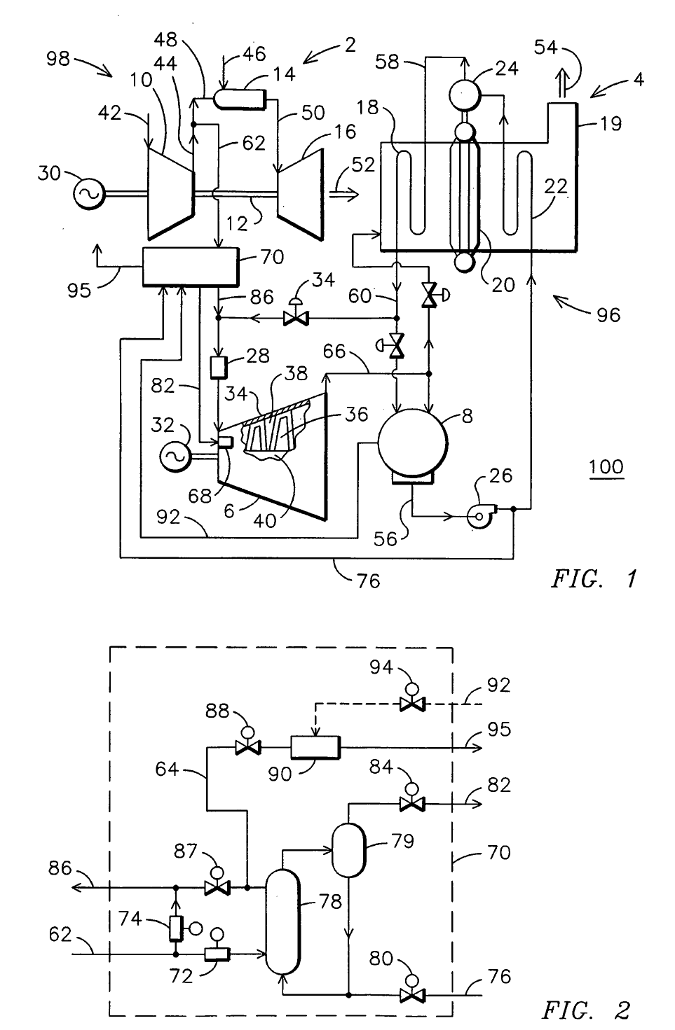

Referring to the drawings, there is shown in FIG. 1 a schematic diagram of a combined cycle power plant 100 including a gas portion 98 and a steam portion 96. The major components of the power plant include a gas turbine engine 2, a heat recovery steam generator (HRSG) 4, a steam turbine 6, and a condenser 8. The gas turbine engine 2 includes a compressor 10, a gas turbine section 16 having a rotor shaft 12 connected to the compressor 10 and to an electrical generator 30, and a combustor 14. The HRSG 4 includes a superheater 18, an evaporator 20, a steam drum 24, and an economizer 22. The steam turbine 6 includes a rotor 40 mounted for rotation within a casing 34 so as to form a flow path for the steam there between. Gland seals 68 prevent the working fluid steam from escaping from the steam flow path. As is conventional, a plurality of the rotating blades 36 and stationary vanes 38 project into the flow path.

In operation, the compressor 10 inducts ambient air 42 and compresses it, thereby producing compressed air 44. The temperature and pressure of the compressed air 44 produced by the compressor 10 will typically be in excess of 260 degrees C. (500 degrees F.) and 700 kPa (100 psi), respectively, when the gas turbine rotor 7 is at steady state operating speed, typically 3600 RPM.

A portion (not shown) of the compressed air 44 produced by the compressor 10 may be directed to the turbine section 16 for cooling therein. During steady state operation of the power plant, the remainder 48 of the compressed air 44 produced by the compressor 10 is directed to the combustor 14, along with a fuel 46. According to one aspect of the current invention a portion 62 of the compressed air 44 produced by the compressor 10 is used during start-up of the plant to eliminate the need for an auxiliary boiler, as discussed further below.

In the combustor 14, the fuel 46, which is typically natural gas or distillate oil, is introduced into the compressed air 48 via a fuel nozzle (not shown). The fuel 46 burns in the compressed air 48, thereby producing a hot combustion gas 50. The hot gas 50 is then directed to the turbine section 16, where it is expanded, thereby producing power in the rotor shaft 12 that drives both the compressor 10 and the electrical generator 30. As a result of having been expanded in the turbine section 16, the temperature of the expanded gas 52 exhausting from the turbine section 16 is considerably less than the temperature of the hot combustion gas 50 entering the turbine section 16. Nevertheless, in a modern gas turbine operating at full load, the temperature of the expanded gas 52 is still relatively hot, typically in the range of 450-600 degrees C. (850-1100 degrees F.).

From the turbine section 16, the expanded gas 52 is directed to the HRSG 4. In the HRSG 4, the expanded gas 52 is directed by ductwork so that it flows successively over the superheater 18, the evaporator 20 and the economizer 22. After flowing through the HRSG 4, the cooled, expanded gas 54 is then discharged to atmosphere via a stack 19. As is conventional, the superheater 18, the evaporator 20 and the economizer 22 may have heat transfer surfaces comprised of finned tubes. The expanded gas 52 flows over these finned tubes and the feed water/steam flows within the tubes. In the HRSG 4, the expanded gas 52 transfers a considerable portion of its heat to the feed water/steam, thereby cooling the gas and transforming the feed water into steam.

In addition to the expanded gas 52 from the gas turbine 2, the HRSG 4 receives a flow of feed water (condensate) 56 from the condenser 4 that has been pressurized by pump 26. As is conventional, the feed water first flows through the heat transfer tubes of the economizer 22, where its temperature is raised to close to saturation temperature. The heated feed water from the economizer 22 is then directed to the steam drum 24. From the steam drum 24, the water is circulated through the heat transfer tubes of the evaporator 20. Such circulation may be by natural means or by forced circulation. The evaporator 20 converts the feed water into saturated steam 58. From the evaporator 20, the saturated steam 58 is directed to the superheater 18, wherein its temperature is raised into the superheat region.

From the superheater 18, the superheated steam 60 is directed to a steam chest 28 that distributes the steam to the inlet of steam turbine 6. In the steam turbine 6, the steam 60 flows through the flow path formed within the casing 34 and over the rows of rotating blades 36 and stationary vanes 38, only a few of which are shown in FIG. 1. In so doing, the steam 60 expands and generates shaft power that drives the rotor 40, which, in turn, drives a second electrical generator 32. Alternatively, the steam turbine rotor 40 and the gas turbine rotor 7 could be coupled to a common shaft that drives a single electrical generator. The expanded steam 66 exhausted from the steam turbine 6 is then directed to the condenser 8 and eventually returned to the HRSG 4.

FIG. 1 identifies an equipment skid 70 that is used in lieu of an auxiliary boiler for at least one of two functions during plant start-up prior to the availability of steam from the HRSG 4: for providing steam to the turbine gland seals 68 and/or for powering a jet pump for evacuating the condenser 8. The skid 70 may be assembled off-site and shipped to the plant site, where it is then connected to the appropriate systems of an existing power plant, either permanently or at least for a period of the start-up of the power plant. It should be appreciated that the equipment and functions embodied by skid 70 are provided as one illustration of the present invention, since back-fit of this invention on existing power plants is contemplated and is simplified by the equipment skid concept. Other embodiments of the invention may include discreet equipment fully integrated with the systems of the power plant. The fluid interconnections between the skid 70 and the remainder of power plant 100 are schematically illustrated in FIG. 1, and details of the specific equipment and interconnections of the skid 70 are illustrated in FIG. 2. The following description should be read with reference to both of these drawings.

Compressed air bleed 62 from the compressor 10 is provided to the skid 70, with flow control valves 72, 74 used to regulate the flow rate to the skid 70 and the flow rate bypassing the skid 70. The compressed air 62 may be bled at its highest temperature from the outlet of the compressor 10, or it may be bled from one of the intermediate stages of the compressor 10 at a somewhat lower temperature. Heat energy is transferred from the compressed air 62 into a flow of condensate 76 within a steam generator 78. Steam generator 78 may be any type of heat exchanger/boiler known in the art; preferably having a low thermal inertia to facilitate the rapid production of steam following the availability of compressed air bleed 62. A moisture separator 79 may be desired, particularly with a once-through steam generator 78. The moisture separator 79 may be a separate component disposed downstream of the steam generator 78, as illustrated, or it may be formed to be integral with the steam generator 78. The flow of condensate may be regulated by flow control valve 80, and the flow of steam to the turbine gland seals 68 through steam line 82 may be regulated by flow control valve 84.

The cooled compressed air 64 leaving steam generator 78, as well as any compressed air bypassed through valve 74, may be provided to another location within the plant, such as to turbine 6, through vent line 86. Alternatively, flow control valves 87, 88 may direct the cooled compressed air to air ejector 90. The air ejector 90 is also connected to the condenser 8 via evacuation line 92 and flow control valve 94 so that the cooled compressed air 64 passing through the air ejector 90 will draw off fluids such as non-condensable gasses from the condenser 8 in order to establish a vacuum (i.e. a lowered pressure, not necessarily an absolute vacuum) in the condenser 8. The combined flow may then be vented to atmosphere or otherwise processed via vent line 95. One skilled in the art will appreciate that flow control valves, flow sensors, temperature sensors, power and control systems, safety equipment, etc. may be included on equipment skid 70 as necessary to accomplish the desired functioning of the system or as required by applicable design specifications. The specific flow paths, equipment and interconnections illustrated in FIGS. 1 and 2 are provided by way of example and are not intended to be limiting to the claimed invention.

Heat energy may be removed from the compressor bleed air 62 by other heat exchange devices or methods, with the removed heat being used in any desired manner or being dumped to the environment. The cooled compressed air retains its pressure/flow characteristics and may therefore be used as the driving force in any type of jet pump device, such as air ejector 90. Other embodiments may utilize the heat from the compressed air bleed for other purposes, such as for heating other portions of the plant 100, for example. Alternatively, hot compressed air from the compressor 10 may be provided directly to the air ejector 90, and heat may or may not be removed from the airflow downstream of the air ejector 90.

During start-up of a combined cycle power plant, the compressed air discharged from the compressor 10 will very quickly achieve a temperature high enough to create steam in steam generator 78. For example, in one embodiment, the temperature of the compressed air bleed 62 may be in excess of 200° C. (360° F.) in as little as 10 minutes after the initial rolling of the gas turbine shaft 12. Furthermore, the flow of bleed air 62 may be used almost immediately to begin evacuating the condenser 8 via air ejector 90. Accordingly, the prior art delays associated with the warming of the heat recovery steam generator 4 and costs associated with an auxiliary boiler may be avoided while achieving rapid start-up of the plant 100.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

1. A power plant comprising:
a gas portion comprising a compressor for producing compressed air, a combustor for receiving the compressed air and a fuel to produce hot combustion gas, and a gas turbine for expanding the hot combustion gas to produce shaft power and expanded gas;
a steam portion comprising a heat recovery steam generator for receiving the expanded gas and condensate for producing steam, a steam turbine for expanding the steam for producing shaft power and producing expanded steam, and a condenser for condensing the expanded steam to produce the condensate;
an air ejector receiving a portion of the compressed air from the compressor during start-up of the power plant for drawing a vacuum in the condenser; and
a boiler receiving a portion of the compressed air from the compressor during start-up of the power plant for providing steam to gland seals of the steam turbine.

2. The power plant of claim 1, wherein the air ejector and boiler are installed on an equipment skid for installation at the power plant.

3. The power plant of claim 1, wherein the air ejector is disposed downstream of the boiler for receiving its portion of the compressed air from the boiler.

4. A combined cycle power plant wherein the improvement comprises:
a compressed air bleed from a compressor of a gas turbine engine of the power plant; and
a steam generator receiving compressed air from the compressed air bleed and producing steam.

5. The combined cycle power plant of claim 4, wherein the improvement further comprises a fluid connection between the steam generator and a seal of a steam turbine of the plant for the delivery of steam to the seal during start-up of the power plant.

6. The combined cycle power plant of claim 4, wherein the improvement further comprises an air ejector receiving the compressed air from the steam generator for drawing fluid from a condenser of the power plant during start-up of the power plant.

7. The combined cycle power plant of claim 6, wherein the improvement further comprises the air ejector and boiler being installed on an equipment skid for installation at the power plant.

8. A combined cycle power plant wherein the improvement comprises:
a compressed air bleed from a compressor of a gas turbine engine of the power plant; and
an air ejector receiving compressed air from the compressed air bleed and drawing fluid from a condenser of a steam portion of the power plant during start-up of the power plant.

9. The combined cycle power plant of claim 8, wherein the improvement further comprises a heat exchanger for removing heat energy from the compressed air bled from the compressor.

10. The combined cycle power plant of claim 8, wherein the improvement further comprises the heat exchanger being disposed upstream of the air ejector.

11. The combined cycle power plant of claim 10, wherein the improvement further comprises the heat exchanger comprising a boiler producing steam.

12. The combined cycle power plant of claim 11, wherein the improvement further comprises a fluid connection between the boiler and a gland seal of a steam turbine of the power plant.

13. A method of starting a combined cycle power plant, the power plant comprising a gas portion comprising a compressor, a combustor and a gas turbine, the power plant further comprising a steam portion comprising a heat recovery steam generator, a steam turbine and a condenser, the method comprising:
starting the compressor to produce compressed air;
directing a portion of the compressed air to a boiler to produce steam by extracting heat energy from the compressed air; and
directing the steam to a seal of the steam turbine.

14. The method of claim 13, further comprising:
directing at least a portion of the compressed air from the boiler to an air ejector; and
using the air ejector to draw fluid from the condenser.

15. A method of starting a combined cycle power plant, the power plant including a gas portion having a compressor, combustor and gas turbine, and including a steam portion having a heat recovery steam generator, a steam turbine and a condenser, the method comprising:
starting the compressor to produce compressed air; and
directing a portion of the compressed air to an air ejector for drawing air from the condenser during start-up of the plant.

16. The method of claim 15, further comprising:
directing the portion of the compressed air to a steam generator to create steam; and
directing the steam to a gland seal of the steam turbine prior to availability of steam of predetermined characteristics from the heat recovery steam generator.

17. The method of claim 15, further comprising mounting the steam generator and the air ejector on a skid for at least temporary location at the power plant during a period of start-up of the power plant.
